(19) United States
(12) Patent Application Publication
(10) Pub. No.: US 2016/0248533 A1
(43) Pub. Date: Aug. 25, 2016

(54) MEASUREMENT CONFIGURATION METHOD, IDENTIFICATION AND MEASUREMENT METHOD, MACRO BASE STATION, AND UE

(71) Applicant: Huawei Technologies Co., Ltd., Shenzhen (CN)

(72) Inventors: Anjian Li, Beijing (CN); Dengkun Xiao, Shenzhen (CN); Hong Li, Beijing (CN); Chen Zuo, Beijing (CN)

(21) Appl. No.: 15/142,757

(22) Filed: Apr. 29, 2016

Related U.S. Application Data
(63) Continuation of application No. PCT/CN2013/086292, filed on Oct. 31, 2013.

(51) Int. Cl. H04J 11/00; H04W 52/02; H04W 48/10

(52) U.S. Cl. CPC H04J 11/0086; H04W 48/10; H04J 11/0073; H04J 11/0076; H04W 52/0216

(57) ABSTRACT

Embodiments of the present invention disclose a measurement configuration method, an identification and measurement method, a macro base station, and UE. The measurement configuration method provided in the embodiments of the present invention includes: configuring, by a macro base station, a first measurement gap pattern for UE; receiving, by the macro base station, indication information sent by the UE, where the indication information is used to represent that quality of a signal radiated by a small base station and received by the UE is higher than or equal to a preset signal quality threshold; and configuring, by the macro base station, a second measurement gap pattern for the UE, where a measurement gap period in the second measurement gap pattern is less than a measurement gap period in the first measurement gap pattern.

### CROSS REFERENCE TO RELATED APPLICATION

This application is a continuation of International Application No. PCT/CN2013/086292, filed on Oct. 31, 2013, which is hereby incorporated by reference in its entirety.

### TECHNICAL FIELD

Embodiments of the present invention relate to the field of communications technologies, and in particular, to a measurement configuration method, an identification and measurement method, a macro base station, and UE.

### BACKGROUND

In an application scenario in which both a small base station and a macro base station are deployed, to enable a function, of the small base station, of assisting the macro base station in sharing load, it is required that when user equipment (UE) is close to the small base station, the UE can identify the small base station in time, perform radio resource management (RRM) measurement of the small base station, and then report a measurement result to the macro base station. Finally, the macro base station eventually determines, by combining the measurement result of the UE and other input conditions such as network load and a user service priority, whether to hand over the UE to a small cell of the small base station, so that the small cell of the small base station continues to provide a service to a user. Therefore, identification and measurement of an inter-frequency cell by the UE need to be researched.

In the prior art, identification and measurement of an inter-frequency cell are generally implemented by configuring a measurement gap for UE. The measurement gap is suspending, by a serving cell according to a particular period, data reception and transmission for UE or some UEs, and during the suspension, these UEs may tune carrier frequencies of the UEs to other carrier frequencies, attempt to identify a cell on the other carrier frequencies, and measure the identified cell.

It is assumed that F1 is a macro base station, F2 is a small base station, and the macro base station F1 and the small base station F2 have different carrier frequencies. Typically, a small base station is generally deployed in a high frequency band, for example, 3.5 GHz, and a macro base station is generally deployed in a relatively low frequency band, for example, 2 GHz. Assuming that a cell of the macro base station F1 provides a service to UE currently, F1 needs to suspend the service, and the UE needs to tune to a carrier frequency of F2, identify and measure a cell that may exist in F2, and then report a measurement result to the serving base station F1 in a case in which the measurement result meets a preset condition.

In the prior art, a measurement gap pattern configured by the macro base station for the UE is generally fixed and unchanged, as shown in Table 1.

TABLE 1

| | | | Minimum available |
|---|---|---|---|
| | | | time (millisecond) |
| | | | for inter-frequency |
| Measurement | Measurement | Measurement | cell measurement |
| gap pattern | gap length | gap period | within 480 |
| identity | (millisecond) | (millisecond) | milliseconds |
| 1 | 6 | 80 | 30 |

When the macro base station configures, for the UE, a measurement gap pattern whose measurement gap pattern identity is 1, that is, a configured measurement gap period is 80 milliseconds, a measurement gap length is 6 ms, and a time that may be used for measurement within 6 ms is 5 ms, a minimum available time for inter-frequency cell measurement within 480 ms T_{Inter}=(480/80)*5 ms=30 ms.

When the UE is in a continuous reception mode, an identification time of the UE for a small cell is related to a measurement gap period in a measurement gap pattern, and a specific identification time may be calculated by using the following formula:

L_{Identify-Inter}=T_{Basic-Identify-Inter}*(480/T_{Inter})*N_{Freq}

where T_{Basic-Identify-Inter} is a fixed value and is equal to 480 milliseconds, T_{Inter} is a minimum available time for inter-frequency cell measurement within 480 milliseconds, a value of T_{Inter} is determined by a configured measurement gap period, and N_{Freq} is a total quantity of inter-frequency carriers and carriers of a heterogeneous system network in current coverage.

When the UE is in a discontinuous reception mode, an identification time of the UE for a small cell is related to a current discontinuous reception (DRX) period of the UE; therefore, herein only a case in which the UE is in a signal continuous reception mode is considered.

Specifically, an example of calculating a time for the UE in a signal continuous reception mode to identify a small cell is as follows:

It is assumed that there are three networks in current coverage, for example, a Global System for Mobile Communications (GSM), LTE, and a Universal Mobile Telecommunications System (UMTS) overlap, that is, N_{Freq} is equal to 3.

A time needed by the UE to identify a small cell of a small base station by using a measurement gap pattern 1 is:

L_{Identify-Inter}=T_{Basic-Identify-Inter}*(480/T_{Inter})*N_{Freq}=480*(480/30)*3=23040 milliseconds=23.04 seconds

When the UE is relatively far away from the small base station, there is a low probability that the UE is handed over to the small base station and the small base station provides a service. However, the UE needs to perform identification and measurement according to a pre-configured measurement gap pattern, for example, perform measurement according to a measurement gap pattern 1. Relatively, if measurement frequency is higher, the cost is that a current throughput of the macro base station is affected. Moreover, frequent identification and measurement of a small cell by the UE also cause a meaningless waste of power consumption of the UE.

When the UE is relatively close to the small cell, there is a high probability that the UE is handed over to the small base station and the small base station provides a service. Likewise, the UE still needs to perform measurement by using a preset measurement gap pattern, that is, perform measurement according to the measurement gap pattern 1, which may cause an excessively long time for cell search. As a result, the UE cannot identify the small cell of the small base station in time. In this case, the UE also cannot be connected to the small cell of the small base station in time, and therefore the UE cannot achieve in time an objective of sharing load by using the small cell.

### SUMMARY

Embodiments of the present invention provide a measurement configuration method, an identification and measurement method, a macro base station, and UE, which can reduce unnecessary power consumption of UE, and can achieve an objective of sharing load in time by using a small cell.

A first aspect of the embodiments of the present invention provides a measurement configuration method, including: configuring, by a macro base station, a first measurement gap pattern for user equipment UE, where the first measurement gap pattern refers to a data format that is set by the macro base station for suspending data transmission with the UE when the UE identifies and measures a small base station;

receiving, by the macro base station, indication information sent by the UE, where the indication information is used to represent that quality of a signal radiated by the small base station and received by the UE is higher than or equal to a preset signal quality threshold, where the quality of the signal radiated by the small base station is obtained through measurement by the UE according to the first measurement gap pattern; and

configuring, by the macro base station, a second measurement gap pattern for the UE, where a measurement gap period in the second measurement gap pattern is less than a measurement gap period in the first measurement gap pattern.

With reference to the first aspect of the embodiments of the present invention, in a first implementation manner of the first aspect of the embodiments of the present invention, before the receiving, by the macro base station, indication information sent by the UE, the method further includes: sending, by the macro base station to the UE, carrier frequency information used by the small base station, reception time window information of the signal radiated by the small base station, and a physical cell identity list.

With reference to the first aspect of the embodiments of the present invention, or the first implementation manner of the first aspect, in a second implementation manner of the first aspect of the embodiments of the present invention, the quality of the signal refers to power or a signal-to-interference-plus-noise ratio of the received signal.

A second aspect of the embodiments of the present invention provides an identification and measurement method, where the method includes: receiving, by user equipment UE according to a first measurement gap pattern configured by a macro base station, a signal radiated by a small base station, measuring quality of the signal, and identifying and measuring a small cell of the small base station based on the signal;

when the UE determines that the quality of the signal is higher than or equal to a preset signal quality threshold, sending, by the UE, indication information to the macro base station, where the indication information is used to request the macro base station to configure a second measurement gap pattern for the UE, and a measurement gap period in the second measurement gap pattern is less than a measurement gap period in the first measurement gap pattern; and

receiving, by the UE, the second measurement gap pattern configured by the macro base station, receiving, according to the second measurement gap pattern, the signal radiated by the small base station, and identifying and measuring the small cell of the small base station based on the received signal radiated by the small base station.

With reference to the second aspect of the embodiments of the present invention, in a first implementation manner of the second aspect of the embodiments of the present invention, before the receiving, by UE according to a first measurement gap pattern configured by a macro base station, a signal radiated by a small base station, the method further includes: receiving, by the UE, carrier frequency information used by the small base station, reception time window information of the signal radiated by the small base station, and a physical cell identity list that are sent by the macro base station.

With reference to the second aspect of the embodiments of the present invention, or the first implementation manner of the second aspect, in a second implementation manner of the second aspect of the embodiments of the present invention, before the receiving, by UE according to a first measurement gap pattern configured by a macro base station, a signal radiated by a small base station, the method further includes: switching, by the UE, to a signal continuous reception mode.

With reference to the second aspect of the embodiments of the present invention, or the first implementation manner of the second aspect, or the second implementation manner of the second aspect, in a third implementation manner of the second aspect of the embodiments of the present invention, before the receiving, by UE according to a first measurement gap pattern configured by a macro base station, a signal radiated by a small base station, the method further includes: activating, by the UE, an idle radio frequency link, to identify and measure the small cell of the small base station.

With reference to the second aspect of the embodiments of the present invention, or the first implementation manner of the second aspect, or the second implementation manner of the second aspect, or the third implementation manner of the second aspect, in a fourth implementation manner of the second aspect of the embodiments of the present invention, the signal is a primary synchronization signal PSS, a secondary synchronization signal SSS or another pilot signal.

With reference to the second aspect of the embodiments of the present invention, or the first implementation manner of the second aspect, or the second implementation manner of the second aspect, or the third implementation manner of the second aspect, or the fourth implementation manner of the second aspect, in a fifth implementation manner of the second aspect of the embodiments of the present invention, the quality of the signal refers to power or a signal-to-interference-plus-noise ratio of the signal.

With reference to the second aspect of the embodiments of the present invention, or the first implementation manner of the second aspect, or the second implementation manner of the second aspect, or the third implementation manner of the second aspect, or the fourth implementation manner of the second aspect, or the fifth implementation manner of the second aspect, in a sixth implementation manner of the second aspect of the embodiments of the present invention, the signal quality threshold is set by the macro base station and notified to the UE by means of broadcasting or by using a radio resource control RRC dedicated message, or is set by the UE.

A third aspect of the embodiments of the present invention provides a macro base station, where the macro base station includes: a configuration unit, configured to configure a first measurement gap pattern for user equipment UE, where the first measurement gap pattern refers to a data format that is set by the macro base station for suspending data transmission with the UE when the UE identifies and measures a small base station; and

a receiving unit, configured to receive indication information sent by the UE, where the indication information is used to represent that quality of a signal radiated by the small base station and received by the UE is higher than or equal to a preset signal quality threshold, where the quality of the signal radiated by the small base station is obtained through measurement by the UE according to the first measurement gap pattern, where

the configuration unit is further configured to: after the receiving unit receives the indication information sent by the UE, configure a second measurement gap pattern for the UE, where a measurement gap period in the second measurement gap pattern is less than a measurement gap period in the first measurement gap pattern.

With reference to the third aspect of the embodiments of the present invention, in a first implementation manner of the third aspect of the embodiments of the present invention, the macro base station further includes: a sending unit, configured to send, to the UE, carrier frequency information used by the small base station, reception time window information of the signal radiated by the small base station, and a physical cell identity list.

With reference to the third aspect of the embodiments of the present invention, or the first implementation manner of the third aspect, in a second implementation manner of the third aspect of the embodiments of the present invention, the quality of the signal refers to power or a signal-to-interference-plus-noise ratio of the received signal.

A fourth aspect of the embodiments of the present invention provides user equipment UE, where the UE includes: a receiving unit, configured to receive, according to a first measurement gap pattern configured by a macro base station, a signal radiated by a small base station;

a processing unit, configured to measure quality of the signal received by the receiving unit, and identify and measure a small cell of the small base station based on the signal received by the receiving unit; and

a sending unit, configured to: when the processing unit determines that the quality of the signal is higher than or equal to a preset signal quality threshold, send indication information to the macro base station, where the indication information is used to request the macro base station to configure a second measurement gap pattern for the UE, and a measurement gap period in the second measurement gap pattern is less than a measurement gap period in the first measurement gap pattern, where

the receiving unit is further configured to receive the second measurement gap pattern configured by the macro base station, and receive, according to the second measurement gap pattern, the signal radiated by the small base station; and

the processing unit is further configured to identify and measure the small cell of the small base station based on the signal received, according to the second measurement gap pattern, by the receiving unit.

With reference to the fourth aspect of the embodiments of the present invention, in a first implementation manner of the fourth aspect of the embodiments of the present invention, before receiving, according to the first measurement gap pattern configured by the macro base station, the signal radiated by the small base station, the receiving unit is further configured to receive carrier frequency information used by the small base station, reception time window information of the signal radiated by the small base station, and a physical cell identity list that are sent by the macro base station.

With reference to the fourth aspect of the embodiments of the present invention, or the first implementation manner of the fourth aspect, in a second implementation manner of the fourth aspect of the embodiments of the present invention, the UE further includes: a switching unit, configured to: before the receiving unit receives, according to the first measurement gap pattern configured by the macro base station, the signal radiated by the small base station, switch from a signal discontinuous reception mode to a signal continuous reception mode.

With reference to the fourth aspect of the embodiments of the present invention, or the first implementation manner of the fourth aspect, or the second implementation manner of the fourth aspect, in a third implementation manner of the fourth aspect of the embodiments of the present invention, the UE further includes: a link activation unit, configured to: before the receiving unit receives, according to the first measurement gap pattern configured by the macro base station, the signal radiated by the small base station, activate an idle radio frequency link, to identify and measure the small cell of the small base station.

With reference to the fourth aspect of the embodiments of the present invention, or the first implementation manner of the fourth aspect, or the second implementation manner of the fourth aspect, or the third implementation manner of the fourth aspect, in a fourth implementation manner of the fourth aspect of the embodiments of the present invention, the signal is a primary synchronization signal PSS, a secondary synchronization signal SSS or another pilot signal.

With reference to the fourth aspect of the embodiments of the present invention, or the first implementation manner of the fourth aspect, or the second implementation manner of the fourth aspect, or the third implementation manner of the fourth aspect, or the fourth implementation manner of the fourth aspect, in a fifth implementation manner of the fourth aspect of the embodiments of the present invention, the quality of the signal refers to power or a signal-to-interference-plus-noise ratio of the signal.

With reference to the fourth aspect of the embodiments of the present invention, or the first implementation manner of the fourth aspect, or the second implementation manner of the fourth aspect, or the third implementation manner of the fourth aspect, or the fourth implementation manner of the fourth aspect, or the fifth implementation manner of the fourth aspect, in a sixth implementation manner of the fourth aspect of the embodiments of the present invention, the signal quality threshold is set by the macro base station and notified to the UE by means of broadcasting or by using a radio resource control RRC dedicated message, or is set by the UE.

A fifth aspect of the embodiments of the present invention provides another macro base station, where the macro base station includes : a first processor, configured to configure a first measurement gap pattern for user equipment UE, where the first measurement gap pattern refers to a data format that is set by the macro base station for suspending data transmission with the UE when the UE identifies and measures a small base station; and

a first receiver, configured to receive indication information sent by the UE, where the indication information is used to represent that quality of a signal radiated by the small base station and received by the UE is higher than or equal to a preset signal quality threshold, where the quality of the signal radiated by the small base station is obtained through measurement by the UE according to the first measurement gap pattern, where

the first processor is further configured to: after the first receiver receives the indication information sent by the UE, configure a second measurement gap pattern for the UE, where a measurement gap period in the second measurement gap pattern is less than a measurement gap period in the first measurement gap pattern.

With reference to the fifth aspect of the embodiments of the present invention, in a first implementation manner of the fifth aspect of the embodiments of the present invention, the macro base station further includes: a first transmitter, configured to send, to the UE, carrier frequency information used by the small base station, reception time window information of the signal radiated by the small base station, and a physical cell identity list.

A sixth aspect of the embodiments of the present invention provides another UE, where the UE includes: a second receiver, configured to receive, according to a first measurement gap pattern configured by a macro base station, a signal radiated by a small base station;

a second processor, configured to measure quality of the signal received by the second receiver, and identify and measure a small cell of the small base station based on the signal received by the second receiver; and

a second transmitter, configured to: when the second processor determines that the quality of the signal is higher than or equal to a preset signal quality threshold, send indication information to the macro base station, where the indication information is used to request the macro base station to configure a second measurement gap pattern for the UE, and a measurement gap period in the second measurement gap pattern is less than a measurement gap period in the first measurement gap pattern, where

the second receiver is further configured to receive the second measurement gap pattern configured by the macro base station, and receive, according to the second measurement gap pattern, the signal radiated by the small base station; and

the second processor is further configured to identify and measure the small cell of the small base station based on the signal received, according to the second measurement gap pattern, by the second receiver.

With reference to the sixth aspect of the embodiments of the present invention, in a first implementation manner of the sixth aspect of the embodiments of the present invention, the second receiver is further configured to: before receiving, according to the first measurement gap pattern configured by the macro base station, the signal radiated by the small base station, receive carrier frequency information used by the small base station, reception time window information of the signal radiated by the small base station, and a physical cell identity list that are sent by the macro base station.

With reference to the sixth aspect of the embodiments of the present invention, or the first implementation manner of the sixth aspect, in a second implementation manner of the sixth aspect of the embodiments of the present invention, the second processor is further configured to: before the second receiver receives, according to the first measurement gap pattern configured by the macro base station, the signal radiated by the small base station, switch to a signal continuous reception mode.

With reference to the sixth aspect of the embodiments of the present invention, or the first implementation manner of the sixth aspect, or the second implementation manner of the sixth aspect, in a third implementation manner of the sixth aspect of the embodiments of the present invention, the second processor is further configured to: before the second receiver receives, according to the first measurement gap pattern configured by the macro base station, the signal radiated by the small base station, activate an idle radio frequency link, to identify and measure the small cell of the small base station.

It can be seen from the foregoing technical solutions that, the embodiments of the present invention have the following advantages:

In the embodiments of the present invention, a macro base station initially configures a first measurement gap pattern for UE, and when the macro base station receives indication information sent by the UE and used to represent that quality of a signal radiated by a small base station and received by the UE is higher than or equal to a preset signal quality threshold, the macro base station configures a second measurement gap pattern for the UE, where a measurement gap period in the second measurement gap pattern is less than a measurement gap period in the first measurement gap pattern. That is, the macro base station changes the configured measurement gap pattern according to the quality of the radiated signal received by the UE. When the quality of the radiated signal received by the UE is lower than the preset signal quality threshold, the UE may be relatively far away from the small base station, and the macro base station configures a measurement gap pattern including a relatively long measurement gap period (relatively low measurement frequency) for the UE, which can reduce an effect on a throughput of the macro base station and reduce, for the UE, power consumption for identifying and measuring an inter-frequency cell. When the quality of the radiated signal received by the UE is higher than or equal to the preset signal quality threshold, the UE may be already close to a small cell, and the macro base station configures a measurement gap pattern including a relatively short measurement gap period (relatively high measurement frequency) for the UE, which can ensure that the UE identifies and is connected to the small cell of the small base station in time, thereby achieving an objective of sharing load in time by using the small cell.

### BRIEF DESCRIPTION OF THE DRAWINGS

FIG. 1 is a schematic diagram of an embodiment of a measurement configuration method according to an embodiment of the present invention;

FIG. 2 is a schematic diagram of another embodiment of a measurement configuration method according to an embodiment of the present invention;

FIG. 3 is a schematic diagram of an embodiment of an identification and measurement method according to an embodiment of the present invention;

FIG. 4 is a schematic diagram of another embodiment of an identification and measurement method according to an embodiment of the present invention;

FIG. 5 is a schematic diagram of an embodiment of a macro base station according to an embodiment of the present invention;

FIG. 6 is a schematic diagram of another embodiment of a macro base station according to an embodiment of the present invention;

FIG. 7 is a schematic diagram of an embodiment of UE according to an embodiment of the present invention;

FIG. 8 is a schematic diagram of another embodiment of UE according to an embodiment of the present invention;

FIG. 9 is a schematic diagram of another embodiment of a macro base station according to an embodiment of the present invention; and

FIG. 10 is a schematic diagram of another embodiment of UE according to an embodiment of the present invention.

### DETAILED DESCRIPTION

Embodiments of the present invention provide a measurement configuration method, an identification and measurement method, a macro base station, and UE, which can reduce unnecessary power consumption of UE, and can ensure that the UE is connected to a small cell of a small base station in time.

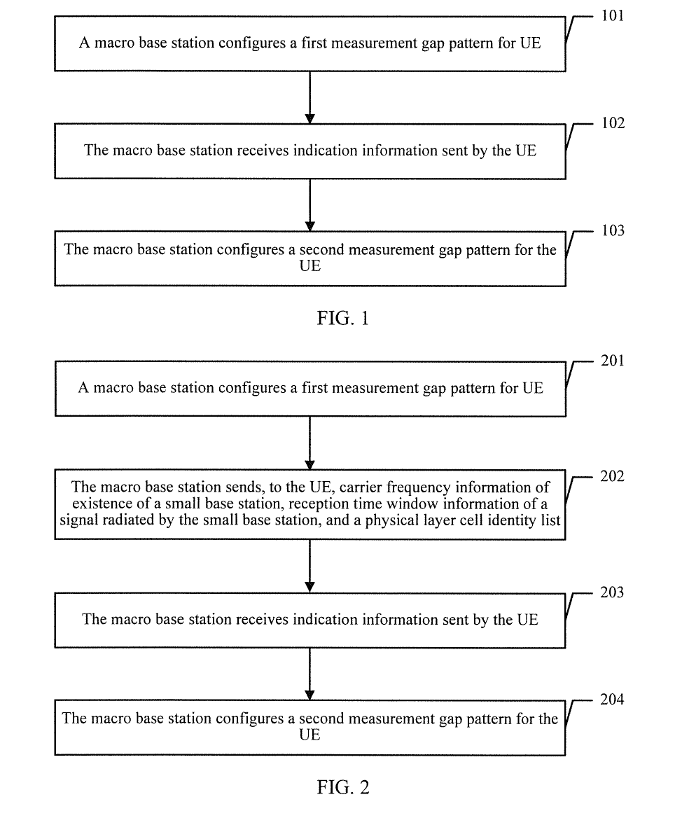

Referring to FIG. 1, an embodiment of a measurement configuration method in the embodiments of the present invention includes:

101: A macro base station configures a first measurement gap pattern for user equipment UE.

When a macro base station provides a service to UE, the macro base station configures a first measurement gap pattern for the UE, so that the UE identifies and measures a small base station that may exist and a small cell of the small base station according to the first measurement gap pattern.

The first measurement gap pattern refers to a data format that is set by the macro base station for suspending data transmission with the UE when the UE identifies and measures a small base station.

102: The macro base station receives indication information sent by the UE.

When a measurement result of the UE meets a condition of reporting a measurement result to the macro base station, that is, when the UE finds through measurement that quality of a received signal radiated by the small base station is higher than or equal to a preset signal quality threshold, the UE sends indication information to the macro base station, and the macro base station receives the indication information sent by the UE.

The indication information may be a simple command, and the command is used to require the macro base station to configure a second measurement gap pattern for the UE; or the indication information includes a measurement result, and when the macro base station receives the indication information, the macro base station configures a second measurement gap pattern for the UE.

103: The macro base station configures a second measurement gap pattern for the UE.

When the macro base station receives the indication information sent by the UE, it indicates that as the UE moves, the UE may be relatively close to the small base station currently, and may desirably receive a signal radiated by the small base station. Therefore, the macro base station configures a second measurement gap pattern for the UE. A measurement gap period in the second measurement gap pattern is less than a measurement gap period in the first measurement gap pattern, that is, the macro base station configures a measurement gap pattern including relatively high measurement frequency for the UE, so that the UE may quickly identify and measure a small cell of the small base station.

Herein, the second measurement gap pattern also refers to a data format that is set by the macro base station for suspending data transmission with the UE when the UE identifies and measures a small base station.

In this embodiment, a macro base station may change a configured measurement gap pattern according to quality of a signal radiated by a small base station and received by UE. When the quality of the radiated signal received by the UE is lower than a preset signal quality threshold, the UE may be relatively far away from the small base station, and the macro base station configures a measurement gap pattern including a relatively long measurement gap period (relatively low measurement frequency) for the UE, which can reduce an effect on a throughput of the macro base station and reduce, for the UE, power consumption for identifying and measuring an inter-frequency cell. When the quality of the radiated signal received by the UE is higher than or equal to a preset signal quality threshold, the UE may be already close to a small cell, and the macro base station configures a measurement gap pattern including a relatively short measurement gap period (relatively high measurement frequency) for the UE, which can ensure that the UE identifies and is connected to the small cell of the small base station in time, and achieve an objective of sharing load in time by using the small cell.

For ease of understanding, the measurement configuration method in the embodiments of the present invention is described below by using a specific example. Referring to FIG. 2, another embodiment of the measurement configuration method according to the embodiments of the present invention includes:

201: A macro base station configures a first measurement gap pattern for user equipment UE.

When a macro base station provides a service to UE, in this case, the UE is relatively close to the macro base station and is relatively far away from a small base station, and the macro base station configures a first measurement gap pattern for the UE, so that the UE identifies and measures a small base station that may exist and a small cell of the small base station according to the first measurement gap pattern.

202: The macro base station sends, to the UE, carrier frequency information used by a small base station, reception time window information of a signal radiated by the small base station, and a physical cell identity list.

To enable the UE to accurately identify and measure a small cell of the small base station, the macro base station sends, to the UE, information such as carrier frequency information used by the small base station, reception time window information of a signal radiated by the small base station, and a physical cell identity (PCI) list that the UE needs to identify.

The carrier frequency information used by the small base station is used to notify the UE of carrier frequencies used by the small base station currently; the reception time window information of the signal radiated by the small base station includes a size, an initial position or the like of a reception time window, and is used to notify the UE of a time period during which the signal radiated by the small base station is received; and the physical cell identity list is used to notify the UE of an identity of a small cell that is of the small base station and needs to be identified.

203: The macro base station receives indication information sent by the UE.

The UE tunes to a specified carrier frequency according to the carrier frequency information sent by the macro base station, and receives, within a specified time period according to the reception time window information sent by the macro base station, a signal radiated by the small base station. The UE measures quality of the received signal, and when the UE finds through measurement that the quality of the received signal radiated by the small base station is higher than or equal to a preset signal quality threshold, the UE sends indication information to the macro base station, and the macro base station receives the indication intonation sent by the UE.

The signal radiated by the small base station may be a primary synchronization signal (PSS), a secondary synchronization signal (SSS) or another pilot signal, and the quality of the signal refers to power or a signal-to-interference-plus-noise ratio of the signal, that is, when the power or the signal-to-interference-plus-noise ratio of the radiated signal received by the UE reaches the preset signal quality threshold, the UE sends the indication information to the macro base station.

The signal quality threshold may be preset by the macro base station, and then notified to the UE by means of broadcasting or by using a radio resource control (RRC) message. Certainly, the signal quality threshold may also be preset by the UE.

The indication information sent by the UE to the macro base station may be a simple command, and the command is used to require the macro base station to configure a second measurement gap pattern for the UE; or the indication information sent by the UE to the macro base station may include a measurement result, and when the macro base station receives the indication information, the macro base station configures a second measurement gap pattern for the UE.

204: The macro base station configures a second measurement gap pattern for the UE.

When the macro base station receives the indication information sent by the UE, it indicates that as the UE moves, the UE may be relatively close to the small base station currently, and may desirably receive a signal radiated by the small base station. Therefore, the macro base station configures a second measurement gap pattern for the UE. A measurement gap period in the second measurement gap pattern is less than a measurement gap period in the first measurement gap pattern, that is, the macro base station configures a measurement gap pattern including relatively high measurement frequency for the UE, so that the UE may quickly identify and measure a small cell of the small base station.

Both the first measurement gap pattern and the second measurement gap pattern in this embodiment refer to a data format that is set by the macro base station for suspending data transmission with the UE when the UE identifies and measures a small base station.

In this embodiment, when a macro base station provides a service to UE, the macro base station sends related information of a small base station to the UE, and the macro base station changes a configured measurement gap pattern according to quality of a signal radiated by the small base station and received by the UE. When the quality of the radiated signal received by the UE is lower than a preset signal quality threshold, the UE may be relatively far away from the small base station, and the macro base station configures a measurement gap pattern including a relatively long measurement gap period (relatively low measurement frequency) for the UE, which can reduce an effect on a throughput of the macro base station and reduce, for the UE, power consumption for identifying and measuring an inter-frequency cell. When the quality of the radiated signal received by the UE is higher than or equal to a preset signal quality threshold, the UE may be already close to a small cell, and the macro base station configures a measurement gap pattern including a relatively short measurement gap period (relatively high measurement frequency) for the UE, which can ensure that the UE identifies and is connected to the small cell of the small base station in time, and achieve an objective of sharing load in time by using the small cell.

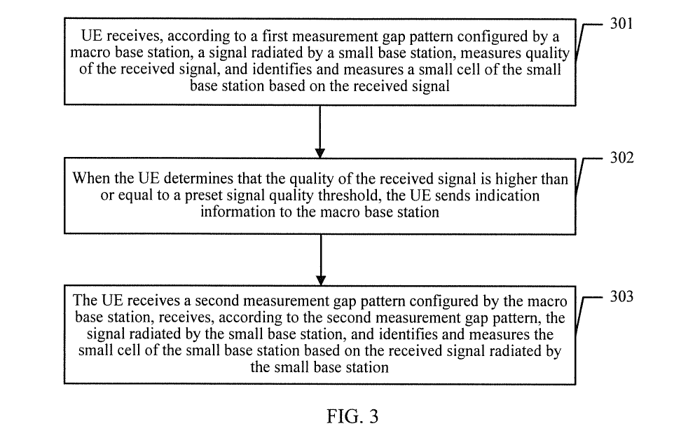

The method for a macro base station to perform measurement configuration for UE is described in the foregoing two embodiments, and a method for UE to identify and measure a small cell of a small base station is described below. First, referring to FIG. 3, an embodiment of an identification and measurement method according to the embodiments of the present invention includes:

301: UE receives, according to a first measurement gap pattern configured by a macro base station, a signal radiated by a small base station, measures quality of the received signal, and identifies and measures a small cell of the small base station based on the received signal.

When a macro base station provides a service to UE, the macro base station configures a first measurement gap pattern for the UE, where the first measurement gap pattern refers to a data format that is set by the macro base station for suspending data transmission with the UE when the UE identifies and measures a small base station.

The UE receives, according to the first measurement gap pattern configured by the macro base station, a signal radiated by the small base station, and identifies and measures, based on the received signal, a small base station that may exist. Herein, the received signal radiated by the small base station may be a PSS signal, an SSS signal or another pilot signal.

302: When the UE determines that the quality of the received signal is higher than or equal to a preset signal quality threshold, the UE sends indication information to the macro base station.

In this embodiment, the signal quality threshold may be preset by the macro base station, and then notified to the UE by means of broadcasting or by using an RRC message, or the signal quality threshold may be preset by the UE according to an actual situation.

After receiving the signal radiated by the small base station, the UE determines whether the quality of the received signal is higher than or equal to a preset signal quality threshold, and if the quality of the received signal is higher than or equal to the preset signal quality threshold, it indicates that the UE is relatively close to the small base station currently, and may desirably receive the signal radiated by the small base station, and the small base station is likely to provide a service.

The UE sends indication information to the macro base station, where the indication information is used to request the macro base station to configure a second measurement gap pattern for the UE, the indication information may be a simple command, and the command is used to require the macro base station to configure a second measurement gap pattern for the UE; or the indication information includes a measurement result, and when the macro base station receives the indication information, the macro base station configures a second measurement gap pattern for the UE.

Specifically, the method for the UE to send the indication information to the macro base station may be implemented by using a protocol data unit (PDU) of a Media Access Control (MAC) layer, or implemented by using RRC signaling. An effect of reporting indication information by using a PDU of a MAC layer is more desirable, because a speed of reporting indication information in this manner is faster than that by using RRC signaling.

303: The UE receives a second measurement gap pattern configured by the macro base station, receives, according to the second measurement gap pattern, the signal radiated by the small base station, and identifies and measures the small cell of the small base station based on the received signal radiated by the small base station.

After receiving the indication information sent by the UE, the macro base station configures a second measurement gap pattern for the UE, where a measurement gap period in the second measurement gap pattern is less than a measurement gap period in the first measurement gap pattern.

UE receives a second measurement gap pattern configured by a macro base station, receives, according to the second measurement gap pattern, a signal radiated by a small base station, and identifies and measures a small cell of the small base station based on the received signal. In this embodiment, when the macro base station provides a service to the UE, the UE determines quality of the received signal radiated by the small base station, and when determining that the quality of the received signal is higher than or equal to a preset signal quality threshold, the UE sends indication information to the macro base station, where the indication information is used to request the macro base station to configure a second measurement gap pattern including a relatively short measurement gap period for the UE, to accelerate identification and measurement of the small cell of the small base station, thereby achieving an objective of sharing load for the macro base station in time by using the small cell.

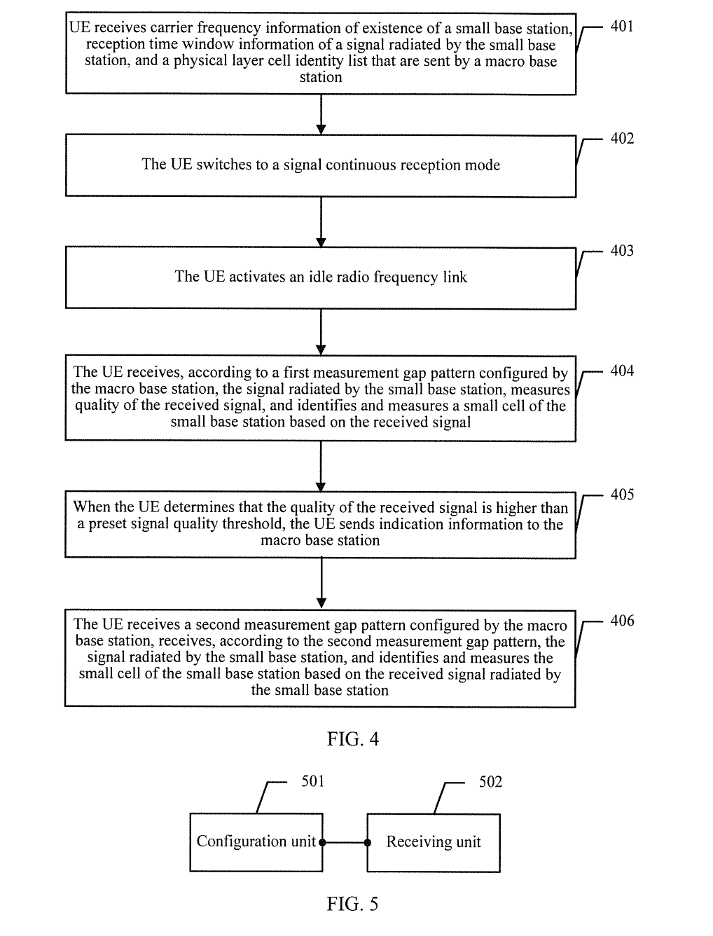

For ease of understanding, the identification and measurement method in the embodiments of the present invention is described below by using a specific example. Referring to FIG. 4, another embodiment of the identification and measurement method in the embodiments of the present invention includes:

401: UE receives carrier frequency information used by a small base station, reception time window information of a signal radiated by the small base station, and a physical cell identity list that are sent by a macro base station.

When the UE enters an area covered by the macro base station, and the macro base station provides a service, to enable the UE to accurately identify and measure the small base station and therefore to achieve an objective of sharing load by the small base station for the macro base station, the macro base station delivers carrier frequency information used by the small base station, reception time window information of a signal radiated by the small base station, a physical cell identity PCI list and the like to the UE, and the UE receives this information sent by the macro base station.

The carrier frequency information used by the small base station is used to notify the UE of carrier frequencies used by the small base station currently, and generally, a carrier frequency used by a small base station is higher than a carrier frequency used by a macro base station. The reception time window information of the signal radiated by the small base station includes a size, an initial position or the like of a reception time window, and is used to notify the UE of a time period during which the signal radiated by the small base station is received. The physical cell identity list is used to notify the UE of an identity of a small cell that is of the small base station and needs to be identified.

402: The UE switches to a signal continuous reception mode.

To reduce power, in a case of only some non-real time applications, the UE generally does not need to ceaselessly monitor downlink data and perform related processing; therefore, the UE is in a signal discontinuous reception (DRX) mode.

If in this case, the UE is in the signal discontinuous reception mode, after the UE receives this information such as carrier frequency information used by the small base station, reception time window information of a signal radiated by the small base station, and a physical cell identity list that are sent by the macro base station, the UE may immediately switch to a signal continuous reception mode, to accelerate subsequent identification and measurement of a small cell of the small base station.

403: The UE activates an idle radio frequency link.

Further, if there is an idle radio frequency link in this case, after switching to the signal continuous reception mode, the UE may activate the idle radio frequency link, which is dedicated to identification and measurement of a small cell that exists in the small base station. In this case, a service of a current cell is not interrupted.

404: The UE receives, according to a first measurement gap pattern configured by the macro base station, the signal radiated by the small base station, measures quality of the received signal, and identifies and measures a small cell of the small base station based on the received signal.

In this case, the macro base station interrupts the service of the current cell, and the UE receives, according to the first measurement gap pattern configured by the macro base station, the signal radiated by the small base station and measures the quality of the received signal.

Specifically, the UE tunes to a specified carrier frequency (a carrier frequency used by the small base station) according to the received carrier frequency information sent by the macro base station, then receives, at a specified initial position of the specified carrier frequency according to the reception time window information sent by the macro base station, a signal, radiated by the small base station, of a specified time length, measures quality of the received signal, and identifies and measures a small cell of the small base station based on the received signal. The signal radiated by the small base station may be a primary synchronization signal PSS, a secondary synchronization signal SSS or another pilot signal.

405: When the UE determines that the quality of the received signal is higher than a preset signal quality threshold, the UE sends indication information to the macro base station, where the indication information is used to request the macro base station to configure a second measurement gap pattern for the UE.

Herein, the signal quality threshold may be preset by the macro base station according to an actual situation, and is then broadcast to the UE by means of a network or notified to the UE by using an RRC dedicated message. In addition, herein, a signal power threshold may also be preset by the UE.

After receiving a PSS signal, an SSS signal or another pilot radiated by the small base station, the UE determines whether quality of the received signal is higher than or equal to a preset signal quality threshold. Herein, the quality of the signal may refer to power of the received signal, or may refer to a signal-to-interference-plus-noise ratio of the received signal.

When the UE determines that the quality of the received signal is higher than or equal to the preset signal quality threshold, it indicates that as the UE moves, the UE is already close to the small base station. In this case, the UE needs to quickly identify the small base station.

The UE sends indication information to the macro base station, where the indication information is used to request the macro base station to configure a second measurement gap pattern for the UE. A measurement gap period in the second measurement gap pattern is less than a measurement gap period in the first measurement gap pattern, so that measurement frequency can be improved.

The indication information sent by the UE to the macro base station may be a simple command, and the command is used to require the macro base station to configure a second measurement gap pattern for the UE; or the indication information sent by the UE to the macro base station may include a measurement result, and when the macro base station receives the indication information, the macro base station configures a second measurement gap pattern for the UE.

Specifically, the method for the UE to send the indication information to the macro base station may be implemented by using a protocol data unit (PDU) of a Media Access Control (MAC) layer, or implemented by using RRC signaling. An effect of reporting indication information by using a PDU of a MAC layer is more desirable, because a speed of reporting indication information in this manner is faster than that by using RRC signaling.

406: The UE receives the second measurement gap pattern configured by the macro base station, receives, according to the second measurement gap pattern, the signal radiated by the small base station, and identifies and measures the small cell of the small base station based on the received signal radiated by the small base station.

The process in which the UE identifies and measures the small cell of the small base station based on the received signal radiated by the small base station is specifically: The UE parses a received PSS signal to obtain a physical cell identity (ID), then may parse an SSS signal to obtain a group ID of the cell, and may combine the physical layer cell ID and the group ID to obtain a PCI of the current cell. Because each group includes 3 cell IDs, the PCI of the current cell=group ID*3+cell ID. If the calculated PCI of the current cell is the same as a PCI in a PCI list sent by the macro base station, the current cell is the small cell that the UE needs to identify. After identifying the small cell, the UE measures reference signal received power (RSRP) of the identified small cell. When the RSRP of the identified small cell reaches a threshold, the UE reports the identified small cell to the macro base station, and then the macro base station determines whether to hand over the UE to the cell.

The process in which the UE identifies and measures the small cell of the small base station by using different measurement gap patterns is described below by using an example. As shown in Table 2, when the UE determines that the quality of the received signal is higher than or equal to the preset signal quality threshold, that is, the UE is close to the small base station, the UE may use a measurement gap pattern A or B including a relatively short measurement gap period in Table 2, to accelerate identification of the small cell. When the determining result is that the quality of the received signal is lower than the preset signal quality threshold, that is, the UE is relatively far away from the small base station, the UE may use a measurement gap pattern C or D including a relatively long measurement gap period in Table 2, to reduce power consumption.

| | | | Minimum available |
|---|---|---|---|
| | | | time (millisecond) |
| | | | for inter-frequency |
| Measurement | Measurement | Measurement | cell measurement |
| gap pattern | gap length | gap period | within 480 |
| identity | (millisecond) | (millisecond) | milliseconds |
| A | 6 | 10 | 240 |
| B | 6 | 20 | 120 |
| C | 6 | 160 | 15 |
| D | 6 | 240 | 10 |

It can be known from the background that, when the UE is in a signal continuous reception state, a calculation formula of a time for the UE to identify the small cell is as follows:

L_{Identify-Inter}=T_{Basic-Identify-Inter}*(480/T_{Inter})*N_{Freq}

where T_{Basic-Identify-Inter} is a fixed value and is equal to 480 milliseconds, T_{Inter} is a minimum available time for inter-frequency cell measurement within 480 milliseconds, and N_{Freq} is a quantity of network systems in current coverage.

It is assumed that there are 3 network systems in current coverage, that is, N_{Freq} is equal to 3.

When the UE is close to the small base station, if the UE identifies, by using the measurement gap pattern A, a small cell that exists in the small base station, a needed time is:

L_{Identify-Inter}=T_{Basic-Identify-Inter}*(480/T_{Inter})*N_{Freq}=480*(480/240)*3=2880 milliseconds=2.88 seconds

In the prior art, the time needed by the UE to identify, according to the fixed measurement gap pattern 1, the small cell that exists in the small base station is 23.04 seconds; therefore, when the UE is close to the small base station, the identification time is greatly reduced by using the method of this embodiment, and identification efficiency is improved. After identifying the small cell of the small base station, the UE measures the small cell. A specific measurement time is related to a quantity N_{Freq} of network systems in current coverage, and the measurement of the small cell is mainly measuring whether RSRP of the small cell meets a reporting requirement, and if the RSRP of the small cell meets the reporting requirement, the UE reports a measurement result to the macro base station, and the macro base station determines whether to hand over the UE.

In addition, it should be noted that, in this embodiment, steps 402 and 403 are optional steps. In actual application, whether steps 402 and 403 need to be enabled may be determined according to an actual situation of the UE, and when both steps 402 and 403 need to be enabled, the sequence of steps 402 and 403 is also not limited to the sequence provided in this embodiment.

In this embodiment, when a macro base station provides a service to UE, the UE receives related information that is of a small base station and sent by the macro base station, and switches to a continuous reception mode and activates an idle radio frequency link, which is dedicated to identification and measurement of a small cell; the UE receives, according to a first measurement gap pattern and according to the related information that is of the small base station and provided by the macro base station, a signal radiated by the small base station and measures quality of the received signal; when it is determined that the quality of the received signal is higher than or equal to a preset signal quality threshold, the UE sends indication information to the macro base station, to request the macro base station to configure a second measurement gap pattern including a relatively short measurement gap period for the UE, and then the UE identifies and measures the small cell of the small base station according to the second measurement gap pattern including a relatively short measurement gap period, so as to accelerate identification and measurement of the small cell, thereby achieving an objective of sharing load for the macro base station in time by using the small cell.

The macro base station in the embodiments of the present invention that is used to execute the foregoing measurement configuration method is described below. For a basic logic structure of the macro base station, refer to FIG. 5, and an embodiment of the macro base station in the embodiments of the present invention includes:

a configuration unit 501, configured to configure a first measurement gap pattern for user equipment UE, where the first measurement gap pattern refers to a data format that is set by the macro base station for suspending data transmission with the UE when the UE identifies and measures a small base station; and

a receiving unit 502, configured to receive indication information sent by the UE, where the indication information is used to represent that quality of a signal radiated by the small base station and received by the UE is higher than or equal to a preset signal quality threshold, where the quality of the signal radiated by the small base station is obtained through measurement by the UE according to the first measurement gap pattern, where

the configuration unit 501 is further configured to: after the receiving unit 502 receives the indication information sent by the UE, configure a second measurement gap pattern for the UE, where a measurement gap period in the second measurement gap pattern is less than a measurement gap period in the first measurement gap pattern, and the second measurement gap pattern also refers to a data format that is set by the macro base station for suspending data transmission with the UE when the UE identifies and measures a small base station.

In this embodiment, a macro base station may change a configured measurement gap pattern according to quality of a radiated signal received by UE. When the quality of the radiated signal received by the UE is lower than a preset signal quality threshold, the UE may be relatively far away from a small base station, and a configuration unit configures a measurement gap pattern including a relatively long measurement gap period (relatively low measurement frequency) for the UE, which can reduce an effect on a throughput of the macro base station and reduce, for the UE, power consumption for identifying and measuring an inter-frequency cell. When the quality of the radiated signal received by the UE is higher than or equal to a preset signal quality threshold, the UE may be already close to a small cell, and the configuration unit configures a measurement gap pattern including a relatively short measurement gap period (relatively high measurement frequency) for the UE, which can ensure that the UE identifies and is connected to the small cell of the small base station in time, and achieve an objective of sharing load in time by using the small cell.

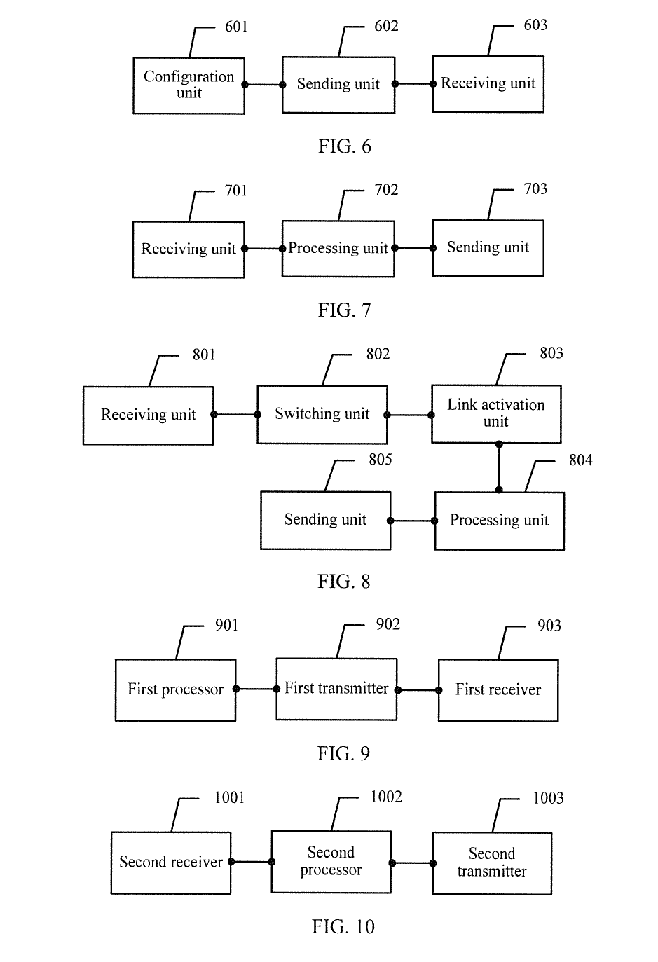

For ease of understanding, the macro base station in the embodiments of the present invention is described below by using a specific example. Referring to FIG. 6, another embodiment of the macro base station in the embodiments of the present invention includes:

a configuration unit 601, configured to configure a first measurement gap pattern for user equipment UE, where the first measurement gap pattern refers to a data format that is set by the macro base station for suspending data transmission with the UE when the UE identifies and measures a small base station; and

a sending unit 602, configured to send, to the UE, carrier frequency information used by the small base station, reception time window information of a signal radiated by the small base station, and a physical cell identity list; and

a receiving unit 603, configured to receive indication information sent by the UE, where the indication information is used to represent that quality of a signal radiated by the small base station and received by the UE is higher than or equal to a preset signal quality threshold, where the quality of the signal radiated by the small base station is obtained through measurement by the UE according to the first measurement gap pattern, and the quality of the signal refers to power or a signal-to-interference-plus-noise ratio of the signal, where

the configuration unit 601 is further configured to: after the receiving unit 603 receives the indication information sent by the UE, configure a second measurement gap pattern for the UE, where a measurement gap period in the second measurement gap pattern is less than a measurement gap period in the first measurement gap pattern.

In this embodiment, when a macro base station provides a service to UE, that is, in this case, the UE is relatively close to the macro base station and relatively far away from a small base station, a configuration unit configures a first measurement gap pattern for the UE, so that the UE identifies and measures a small base station that may exist and a small cell of the small base station according to the first measurement gap pattern, to reduce power consumption. Also, to enable the UE to accurately measure the small cell of the small base station, a sending unit sends, to the UE, information such as carrier frequency information used by the small base station, reception time window information of a signal radiated by the small base station, and a physical cell identity list. When a measurement result of the UE meets a condition of reporting a measurement result to the macro base station, that is, when the UE finds through measurement that quality of the received signal radiated by the small base station is higher than or equal to a preset signal quality threshold, the UE sends indication information to the macro base station, and the receiving unit receives the indication information sent by the UE. The configuration unit configures a second measurement gap pattern for the UE. A measurement gap period in the second measurement gap pattern is less than a measurement gap period in the first measurement gap pattern, that is, the configuration unit configures a measurement gap pattern including relatively high measurement frequency for the UE, so that the UE may quickly identify and measure the small cell of the small base station.

The user equipment UE in the embodiments of the present invention that is used to execute the foregoing identification and measurement method is described below. For a basic logical structure of the UE, refer to FIG. 7, and an embodiment of the UE in the embodiments of the present invention includes:

a receiving unit 701, configured to receive, according to a first measurement gap pattern configured by a macro base station, a signal radiated by a small base station;

a processing unit 702, configured to measure quality of the signal received by the receiving unit 701, and identify and measure a small cell of the small base station based on the signal received by the receiving unit 701; and

a sending unit 703, configured to: when the processing unit 702 determines that the quality of the received signal is higher than or equal to a preset signal quality threshold, send indication information to the macro base station, to request the macro base station to configure a second measurement gap pattern for the UE, where a measurement gap period in the second measurement gap pattern is less than a measurement gap period in the first measurement gap pattern, where

the receiving unit 701 is further configured to receive the second measurement gap pattern configured by the macro base station, and receive, according to the second measurement gap pattern, the signal radiated by the small base station; and

the processing unit 702 is further configured to identify and measure the small cell of the small base station based on the signal received, according to the second measurement gap pattern, by the receiving unit 701.

In this embodiment, when a macro base station provides a service to UE, a receiving unit receives, according to a first measurement gap pattern configured by the macro base station, a signal radiated by a small base station, and a processing unit measures quality of the received signal, and identifies and measures, based on the signal received by the receiving unit, a small base station that may exist. When the processing unit determines that the quality of the received signal is higher than or equal to a preset signal quality threshold, a sending unit sends indication information to the macro base station, where the indication information is used to request the macro base station to configure a second measurement gap pattern for the UE, and a measurement gap period in the second measurement gap pattern is less than a measurement gap period in the first measurement gap pattern. Specifically, the indication information sent by the sending unit may be implemented by using a protocol data unit (PDU) of a Media Access Control (MAC) layer, or implemented by using RRC signaling. An effect of sending indication information by using a PDU of a MAC layer is more desirable, because a speed of reporting indication information in this manner is faster than that by using RRC signaling. After the macro base station configures the second measurement gap pattern for the UE, the receiving unit receives, according to the second measurement gap pattern, the signal radiated by the small base station, and the processing unit identifies and measures a small cell of the small base station based on the received signal.

For ease of understanding, the UE in the embodiments of the present invention is described by using a specific example. Referring to FIG. 8, another embodiment of the UE in the embodiments of the present invention includes:

a receiving unit 801, configured to receive carrier frequency information used by a small base station, reception time window information of a signal radiated by the small base station, and a physical cell identity list that are sent by a macro base station, and the signal radiated by the small base station;

a switching unit 802, configured to switch from a signal discontinuous reception mode to a signal continuous reception mode;

a link activation unit 803, configured to activate an idle radio frequency link, to identify and measure a small cell that exists in the small base station, where

the receiving unit 801 is further configured to receive, according to a first measurement gap pattern configured by the macro base station, the signal radiated by the small base station;

a processing unit 804, configured to measure quality of the signal received by the receiving unit 801, and identify and measure the small cell of the small base station based on the signal received by the receiving unit 801; and

a sending unit 805, configured to: when the processing unit 804 determines that the quality of the received signal is higher than or equal to a preset signal quality threshold, send indication information to the macro base station, to request the macro base station to configure a second measurement gap pattern for the UE, where a measurement gap period in the second measurement gap pattern is less than a measurement gap period in the first measurement gap pattern, where

the receiving unit 801 is further configured to receive the second measurement gap pattern configured by the macro base station, and receive, according to the second measurement gap pattern, the signal radiated by the small base station; and the processing unit 804 is further configured to identify and measure the small cell of the small base station based on the signal received, according to the second measurement gap pattern, by the receiving unit 801.

For ease of understanding, interaction manners between units of the UE in this embodiment are described below by using an actual application scenario.

When the UE enters an area covered by the macro base station, and the macro base station provides a service, to enable the UE to accurately identify and measure the small cell of the small base station, the macro base station delivers carrier frequency information used by the small base station, reception time window information of a signal radiated by the small base station, a physical cell identity list and the like to the UE, and the receiving unit 801 receives this information sent by the macro base station.

The carrier frequency information used by the small base station is used to notify the UE of carrier frequencies used by the small base station currently, and generally, a carrier frequency used by a small base station is higher than a carrier frequency used by a macro base station. The reception time window information of the signal radiated by the small base station includes a size, an initial position or the like of a reception time window, and is used to notify the UE of a time period during which the signal radiated by the small base station is received. The physical cell identity list is used to notify the UE of an identity of a small cell that is of the small base station and needs to be identified.

To reduce power, in a case of only some non-real time applications, the UE generally does not need to ceaselessly monitor downlink data and perform related processing; therefore, the UE is in a signal discontinuous reception (DRX) mode.

If in this case, the UE is in the signal discontinuous reception mode, after the receiving unit 801 receives this information such as carrier frequency information used by the small base station, reception time window information of a signal radiated by the small base station, and a physical cell identity list that are sent by the macro base station, the switching unit 802 may immediately switch to a signal continuous reception mode, to accelerate subsequent identification and measurement of the small cell of the small base station.

Further, if there is an idle radio frequency link in this case, after the switching unit 802 switches to a signal continuous reception mode, the link activation unit 803 may activate the idle radio frequency link, which is dedicated to identification and measurement of a small cell that exists in the small base station. In this case, the macro base station interrupts a service of a current cell.

After the link activation unit 803 activates the idle radio frequency link, the macro base station may interrupt the service of the current cell, and the receiving unit 801 receives, according to the first measurement gap pattern configured by the macro base station, a signal radiated by the small base station. The processing unit 804 measures quality of the signal received by the receiving unit 801.

Specifically, the receiving unit 801 tunes to a specified carrier frequency (a carrier frequency used by the small base station) according to the received carrier frequency information sent by the macro base station, then receives, at a specified initial position of the specified carrier frequency according to the reception time window information sent by the macro base station, a signal, radiated by the small base station, of a specified time length, and the processing unit 804 measures quality of the signal received by the receiving unit 801, and identifies and measures the small cell of the small base station based on the received signal. The signal radiated by the small base station may be a primary synchronization signal PSS, a secondary synchronization signal SSS or another pilot signal.

When the processing unit 804 determines that the quality of the signal received by the receiving unit 801 is higher than or equal to the preset signal quality threshold, it indicates that as the UE moves, the UE is already close to the small base station. In this case, the processing unit 804 needs to quickly identify the small base station.

The sending unit 805 sends indication information to the macro base station, where the indication information is used to request the macro base station to configure a second measurement gap pattern for the UE, and a measurement gap period in the second measurement gap pattern is less than a measurement gap period in the first measurement gap pattern.

Herein, the quality of the signal may refer to power of the received signal, or may refer to a signal-to-interference-plus-noise ratio of the received signal. Herein, the signal quality threshold may be preset by the macro base station according to an actual situation, and is then broadcast to the processing unit 804 by means of a network, or notified to the processing unit 804 by using an RRC dedicated message. In addition, herein, a signal power threshold may also be preset by the processing unit 804.

The indication information sent by the sending unit 805 to the macro base station may be a simple command, and the command is used to require the macro base station to configure a second measurement gap pattern for the UE; or the indication information sent by the UE to the macro base station may include a measurement result, and when the macro base station receives the indication information, the macro base station configures a second measurement gap pattern for the UE.

Specifically, that the sending unit 805 sends indication information to the macro base station may be implemented by using a protocol data unit (PDU) of a Media Access Control (MAC) layer, or may be implemented by using RRC signaling. The speed of sending indication information by using a PDU of a MAC layer is faster.

The receiving unit 801 receives the second measurement gap pattern configured by the macro base station, and receives, according to the second measurement gap pattern, the signal radiated by the small base station, and the processing unit 804 identifies and measures the small cell of the small base station based on the signal that is radiated by the small base station and received, according to the second measurement gap pattern, by the receiving unit 801.

The process in which the processing unit 804 identifies and measures the small cell of the small base station based on the received signal radiated by the small base station is specifically: the processing unit 804 parses a received PSS signal to obtain a physical cell identity (ID), then may parse an SSS signal to obtain a group ID of the cell, and may combine the physical layer cell ID and the group ID to obtain a PCI of the current cell. Because each group includes 3 cell IDs, the PCI of the current cell=group ID*3+cell ID. If the calculated PCI of the current cell is the same as a PCI in a PCI list sent by the macro base station, the current cell is the small cell that the UE needs to identify. A time length for the processing unit 804 to identify the small cell depends on a measurement gap period in a measurement gap pattern.

After identifying the small cell, the processing unit 804 measures reference signal receive power (RSRP) of the identified small cell. When the RSRP of the identified small cell reaches a threshold, the sending unit 805 reports the identified small cell to the macro base station, and then the macro base station determines whether to hand over the UE to the cell. A time length for measurement of the small cell depends on a quantity N_{Freq} of network systems in current coverage.

In this embodiment, when a macro base station provides a service to UE, a receiving unit receives related information that is of a small base station and sent by the macro base station, a switching unit switches to a signal continuous reception mode, and a link activation unit activates an idle radio frequency link, which is dedicated to identification and measurement of a small cell; then the receiving unit receives, according to a first measurement gap pattern configured by the macro base station, a signal radiated by the small base station, a processing unit measures quality of the received signal; when it is determined that the quality of the received signal is higher than or equal to a preset signal quality threshold, a sending unit sends indication information to the macro base station, where the indication information is used to request the macro base station to configure a second measurement gap pattern including a relatively short measurement gap period for the UE, then the processing unit identifies and measures the small cell of the small base station according to the second measurement gap pattern including a relatively short measurement gap period, so as to accelerate identification and measurement of the small cell, thereby achieving an objective of sharing load for the macro base station in time by using the small cell.

The macro base station in the embodiments of the present invention is further described below. Referring to FIG. 9, another embodiment of the macro base station in the embodiments of the present invention includes:

a first processor 901, configured to configure a first measurement gap pattern for user equipment UE, where the first measurement gap pattern refers to a data format that is set by the macro base station for suspending data transmission with the UE when the UE identifies and measures a small base station;

a first transmitter 902, configured to send, to the UE, carrier frequency information used by the small base station, reception time window information of a signal radiated by the small base station, and a physical cell identity list; and

a first receiver 903, configured to receive indication information sent by the UE, where the indication information is used to represent that quality of a signal radiated by the small base station and received by the UE is higher than or equal to a preset signal quality threshold, where the quality of the signal radiated by the small base station is obtained through measurement by the UE according to the first measurement gap pattern, where

the first processor 901 is further configured to: after the first receiver 903 receives the indication information sent by the UE, configure a second measurement gap pattern for the UE, where a measurement gap period in the second measurement gap pattern is less than a measurement gap period in the first measurement gap pattern.

The foregoing signal refers to a PSS signal, an SSS signal or another pilot signal, and the quality of the signal refers to power or a signal-to-interference-plus-noise ratio of the received signal.

The UE in the embodiments of the present invention is further described below. Referring to FIG. 10, another embodiment of the UE in the embodiments of the present invention includes:

a second receiver 1001, configured to receive, according to a first measurement gap pattern configured by a macro base station, a signal radiated by a small base station;

a second processor 1002, configured to measure quality of the signal received by the second receiver 1001, and identify and measure a small cell of the small base station based on the signal received by the second receiver 1001; and

a second transmitter 1003, configured to: when the second processor 1002 determines that the quality of the received signal is higher than or equal to a preset signal quality threshold, send indication information to the macro base station, where the indication information is used to request the macro base station to configure a second measurement gap pattern for the UE, and a measurement gap period in the second measurement gap pattern is less than a measurement gap period in the first measurement gap pattern, where

the second receiver 1001 is further configured to receive the second measurement gap pattern configured by the macro base station, and receive, according to the second measurement gap pattern, the signal radiated by the small base station; and

the second processor 1002 is further configured to identify and measure the small cell of the small base station based on the signal received, according to the second measurement gap pattern, by the second receiver 1001.

In addition, the second receiver 1001 in this embodiment is further configured to: before receiving, according to the first measurement gap pattern configured by the macro base station, the signal radiated by a small base station, receive carrier frequency information used by the small base station, reception time window information of the signal radiated by the small base station, and a physical cell identity list that are sent by the macro base station.

The second processor 1002 is further configured to: before the second receiver 1001 receives, according to a first measurement gap pattern configured by the macro base station, the signal radiated by the small base station, switch to a signal continuous reception mode and activate an idle radio frequency link, to identify and measure the small cell of the small base station.

In this embodiment, the received signal radiated by the small base station is a primary synchronization signal PSS, a secondary synchronization signal SSS or another pilot signal; the quality of the signal refers to power or a signal-to-interference-plus-noise ratio of the signal; and the signal quality threshold may be set by the macro base station and notified to the UE by means of broadcasting or by using a radio resource control RRC dedicated message, or is set by the UE.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or some of the technical solutions may be implemented in the form of a software product. The software product is stored in a storage medium and includes several instructions for instructing a computer device (which may be a personal computer, a server, or a network device) to perform all or some of the steps of the methods described in the embodiments of the present invention. The foregoing storage medium includes: any medium that can store program code, such as a USB flash drive, a removable hard disk, a read-only memory (ROM), a random access memory (RAM), a magnetic disk, or an optical disc.

The foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A measurement configuration method, comprising:
configuring, by a macro base station, a first measurement gap pattern for user equipment (UE), wherein the first measurement gap pattern refers to a data format that is set by the macro base station for suspending data transmission with the UE when the UE identifies and measures a small base station;
receiving, by the macro base station, indication information sent by the UE, wherein the indication information is used to represent that quality of a signal radiated by the small base station and received by the UE is higher than or equal to a preset signal quality threshold, wherein the quality of the signal radiated by the small base station is obtained through measurement by the UE according to the first measurement gap pattern; and
configuring, by the macro base station, a second measurement gap pattern for the UE, wherein a measurement gap period in the second measurement gap pattern is less than a measurement gap period in the first measurement gap pattern.

2. The method according to claim 1, wherein before receiving, by the macro base station, indication information sent by the UE, the method further comprises:
sending, by the macro base station to the UE, carrier frequency information used by the small base station, reception time window information of the signal radiated by the small base station, and a physical cell identity list.

3. The method according to claim 1, wherein the quality of the signal refers to power or a signal-to-interference-plus-noise ratio of the received signal.

4. An identification and measurement method, comprising:
receiving, by user equipment (UE) according to a first measurement gap pattern configured by a macro base station, a signal radiated by a small base station, measuring quality of the signal, and identifying and measuring a small cell of the small base station based on the signal;
when the UE determines that the quality of the signal is higher than or equal to a preset signal quality threshold, sending, by the UE, indication information to the macro base station, wherein the indication information is used to request the macro base station to configure a second measurement gap pattern for the UE, and a measurement gap period in the second measurement gap pattern is less than a measurement gap period in the first measurement gap pattern; and
receiving, by the UE, the second measurement gap pattern configured by the macro base station, receiving, according to the second measurement gap pattern, the signal radiated by the small base station, and identifying and measuring the small cell of the small base station based on the received signal radiated by the small base station.

5. The method according to claim 4, wherein before receiving, by UE according to a first measurement gap pattern configured by a macro base station, a signal radiated by a small base station, the method further comprises:
receiving, by the UE, carrier frequency information used by the small base station, reception time window information of the signal radiated by the small base station, and a physical cell identity list that are sent by the macro base station.

6. The method according to claim 4, wherein before receiving, by UE according to a first measurement gap pattern configured by a macro base station, a signal radiated by a small base station, the method further comprises:
switching, by the UE, to a signal continuous reception mode.

7. The method according to claim 4, wherein before receiving, by UE according to a first measurement gap pattern configured by a macro base station, a signal radiated by a small base station, the method further comprises:
activating, by the UE, an idle radio frequency link, to identify and measure the small cell of the small base station.

8. The method according to claim 4, wherein the signal is a primary synchronization signal (PSS), a secondary synchronization signal (SSS) or another pilot signal.

9. The method according to claim 4, wherein the quality of the signal refers to power or a signal-to-interference-plus-noise ratio of the signal.

10. The method according to claim 4, wherein the signal quality threshold is set by the macro base station and notified to the UE by means of broadcasting or by using a radio resource control (RRC) dedicated message, or is set by the UE.

11. A macro base station, comprising:
a first processor, configured to configure a first measurement gap pattern for user equipment (UE), wherein the first measurement gap pattern refers to a data format that is set by the macro base station for suspending data transmission with the UE when the UE identifies and measures a small base station;
a first receiver, configured to receive indication information sent by the UE, wherein the indication information is used to represent that quality of a signal radiated by the small base station and received by the UE is higher than or equal to a preset signal quality threshold, wherein the quality of the signal radiated by the small base station is obtained through measurement by the UE according to the first measurement gap pattern; and
wherein the first processor is further configured to: after the first receiver receives the indication information sent by the UE, configure a second measurement gap pattern for the UE, wherein a measurement gap period in the second measurement gap pattern is less than a measurement gap period in the first measurement gap pattern.

12. The macro base station according to claim 11, further comprising:
a first transmitter, configured to send, to the UE, carrier frequency information used by the small base station, reception time window information of the signal radiated by the small base station, and a physical cell identity list.

13. The macro base station according to claim 11, wherein the quality of the signal refers to power or a signal-to-interference-plus-noise ratio of the received signal.

14. User equipment (UE), comprising:
a second receiver, configured to receive, according to a first measurement gap pattern configured by a macro base station, a signal radiated by a small base station;
a second processor, configured to measure quality of the signal received by the second receiver, and identify and measure a small cell of the small base station based on the signal received by the second receiver;
a second transmitter, configured to: when the second processor determines that the quality of the signal is higher than or equal to a preset signal quality threshold, send indication information to the macro base station, wherein the indication information is used to request the macro base station to configure a second measurement gap pattern for the UE, and a measurement gap period in the second measurement gap pattern is less than a measurement gap period in the first measurement gap pattern, wherein
the second receiver is further configured to receive the second measurement gap pattern configured by the macro base station, and receive, according to the second measurement gap pattern, the signal radiated by the small base station; and
wherein the second processor is further configured to identify and measure the small cell of the small base station based on the signal received, according to the second measurement gap pattern, by the second receiver.

15. The UE according to claim 14, wherein the second receiver is further configured to:
before receiving, according to the first measurement gap pattern configured by the macro base station, the signal radiated by the small base station, receive carrier frequency information used by the small base station, reception time window information of the signal radiated by the small base station, and a physical cell identity list that are sent by the macro base station.

16. The UE according to claim 14, wherein the second receiver is further configured to:
before the second receiver receives, according to the first measurement gap pattern configured by the macro base station, the signal radiated by the small base station, switch to a signal continuous reception mode.

17. The UE according to claim 14, wherein the second receiver is further configured to:
before the second receiver receives, according to the first measurement gap pattern configured by the macro base station, the signal radiated by the small base station, activate an idle radio frequency link, to identify and measure the small cell of the small base station.

18. The UE according to claim 14, wherein the signal is a primary synchronization signal (PSS), a secondary synchronization signal (SSS) or another pilot signal.

19. The UE according to claim 14, wherein the quality of the signal refers to power or a signal-to-interference-plus-noise ratio of the signal.

20. The UE according to claim 14, wherein the signal quality threshold is set by the macro base station and notified to the UE by means of broadcasting or by using a radio resource control (RRC) dedicated message, or is set by the UE.
